(19) United States
(12) Patent Application Publication
(10) Pub. No.: US 2015/0109631 A1
(43) Pub. Date: Apr. 23, 2015

(54) IMAGE FORMING APPARATUS

(71) Applicant: SHARP KABUSHIKI KAISHA, Osaka (JP)

(72) Inventor: Yasutomo HAYANO, Osaka-shi (JP)

(73) Assignee: SHARP KABUSHIKI KAISHA, Osaka (JP)

(21) Appl. No.: 14/516,654

(22) Filed: Oct. 17, 2014

(30) Foreign Application Priority Data
Oct. 18, 2013 (JP) 2013-217418

(51) Int. Cl. H04N 1/00

(52) U.S. Cl. CPC H04N 1/00095; H04N 1/00408; H04N 1/00307; H04N 1/0097; H04N 1/00973; H04N 2201/0094; H04N 2201/006
USPC 358/1.13

(57) ABSTRACT

An image forming apparatus including: a display unit that displays information relating to a user interface; a UI setting storage unit that stores a setting relating to the user interface; a near field communication unit that communicates with a portable communication terminal via a near field communication to recognize that the portable communication terminal is within a communicable range; an external setting acquiring unit that receives a setting relating to a user interface of the portable communication terminal via the near field communication unit; and a UI setting changing unit that changes the setting stored in the UI setting storage unit based on the setting acquired from the portable communication terminal.

### CROSS-REFERENCE TO RELATED APPLICATION

This application is related to Japanese application No. 2013-217418 filed on Oct. 18, 2013 whose priority is claimed under 35 USC §119, the disclosure of which is incorporated by reference in its entirety.

### BACKGROUND OF THE INVENTION

1. Field of the Invention

The present invention relates to an image forming apparatus that can perform a near field wireless communication with a portable communication terminal.

2. Description of the Background Art

Recently, a device using a technique of a near field wireless communication for personal authentication has been in widespread use. Specific examples of this type of device include a company ID card using a non-contact IC card and Osaifu keitai (registered trademark) (mobile payment service). The near field wireless communication is referred to as a near field communication or NFC. In the NFC, a communicable range (this range is sometimes referred to as a field below) is about 1 meter to a few centimeters. The NFC has standards such as FeliCa (registered trademark) and MIFARE (registered trademark).

Recently, a lot of portable communication terminals, such as smartphones, tablet computers, or mobile computers, have a function of a near field wireless communication. In addition, processing power of the portable communication terminals has been enhanced.

Under such a circumstance, Japanese Unexamined Patent Publication No. 2011-155495, for example, describes a device that performs a user authentication based on authentication information for each user upon giving permission to use an image forming apparatus such as a digital multifunction peripheral, wherein the authentication information is retained by a device having a short-range wireless communication function.

Although processing power of portable communication terminals has been enhanced, the processing power cannot sufficiently be utilized for an operation setting of an image processing apparatus.

For example, a digital multifunction peripheral placed in a public space such as a convenience store is used by unspecified number of users. In such a case, a setting suitable for each user is preferably used for a setting relating to a user interface. For example, most of recent image forming apparatuses include a display unit displaying a message for informing a user of the status or operation method of the corresponding image forming apparatus. However, a user cannot always read Japanese. If he/she can read Japanese, his/her mother language is not always Japanese. In addition, a size of a character easily read by a user is different depending upon an age group or eyesight of each user.

Some image forming apparatuses include a user interface that assists a user's operation with a sound or tone. However, a setting for a suitable sound volume or a language setting of a sound is different depending upon an age group, hearing, and nationality.

An image forming apparatus generally includes a user interface for selecting, changing, or adjusting these settings. However, it cannot be expected that a user bothers to change or adjust the setting in a digital multifunction peripheral set up in the public space described above.

On the other hand, a portable communication terminal having an NFC function such as a smartphone has recently been in widespread use, and many users have his/her portable communication terminal. It can be reasonable to a certain degree that a setting relating to a user interface of a portable communication terminal of each user is used as a setting of a user interface of an image forming apparatus. Specifically, it is expected that there is a correlation to a certain degree between the interface setting of the portable communication terminal and the interface setting of the image forming apparatus.

### SUMMARY OF THE INVENTION

The present invention is accomplished in view of the above circumstance, and aims to provide an image forming apparatus that acquires a setting of a portable communication terminal carried by a user, and can change a setting of a user interface of the image forming apparatus so as to be suitable for the user based on the acquired setting. The present invention provides an image forming apparatus including: a display unit that displays information relating to a user interface; a UI setting storage unit that stores a setting relating to the user interface; a near field communication unit that communicates with a portable communication terminal via a near field communication to recognize that the portable communication terminal is within a communicable range; an external setting acquiring unit that receives a setting relating to a user interface of the portable communication terminal via the near field communication unit; and a UI setting changing unit that changes the setting stored in the UI setting storage unit based on the setting acquired from the portable communication terminal.

The image forming apparatus according to the present invention includes an external setting acquiring unit that receives a setting relating to a user interface of the portable communication terminal via a near field communication unit; and a UI setting changing unit that changes the setting stored in the UI setting storage unit based on the setting acquired from the portable communication terminal. Therefore, the image forming apparatus according to the present invention can acquire the setting of the portable communication terminal carried by the user, and change a setting of a user interface of the image forming apparatus so as to be suitable for the user based on the acquired setting.

### BRIEF DESCRIPTION OF THE DRAWINGS

FIG. 1 is an explanatory view illustrating a state in which an image forming apparatus according to an exemplary embodiment of the present invention communicates with a portable communication terminal with an NFC;

FIG. 2 is a block diagram illustrating configurations of the image forming apparatus and the portable communication terminal illustrated in FIG. 1;

FIG. 3 is an explanatory view illustrating one example of an operation screen displayed on a display unit according to an embodiment of the present invention;

FIG. 4 is an explanatory view illustrating one example of a correspondence relation between a setting on the portable communication terminal and a setting on the image forming apparatus according to the embodiment of the present invention; and

FIG. 5 is a flowchart illustrating a process flow executed by a terminal control unit and a control unit in FIG. 2.

### DESCRIPTION OF THE PREFERRED EMBODIMENTS

The preferred embodiment of the present invention will be described in more detail with reference to the drawings. The description below is presented by way of example only, and is not intended to limit the scope of the present invention.

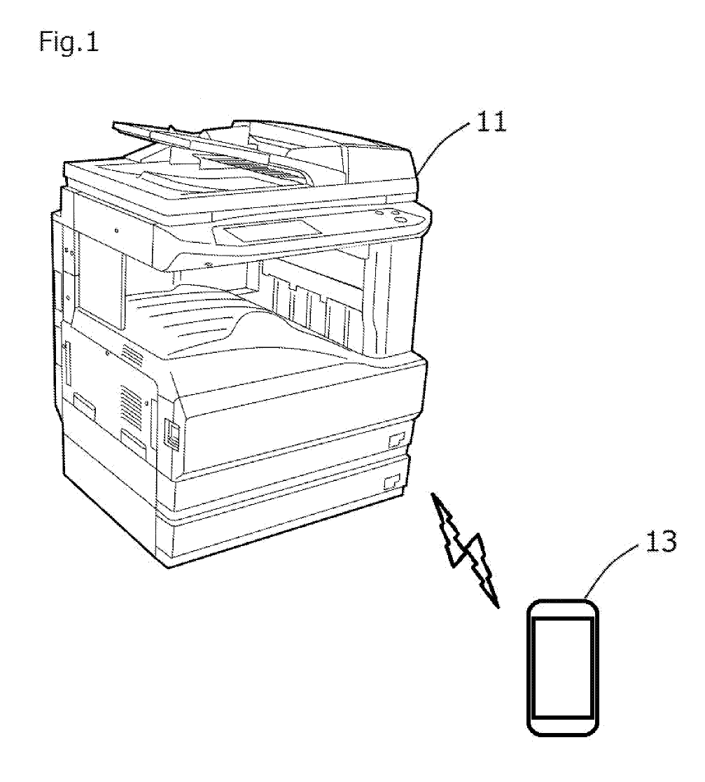

FIG. 1 is an explanatory view describing a state in which an image forming apparatus according to the present exemplary embodiment communicates with a portable communication terminal with an NFC. In the NFC, communicable range is from a few centimeters to about 1 meter. Therefore, when a portable communication terminal 13 is recognized within the communicable range about a near field communication unit provided in an image forming apparatus 11, it can be supposed that this portable communication terminal 13 is carried by a user using the image forming apparatus 11.

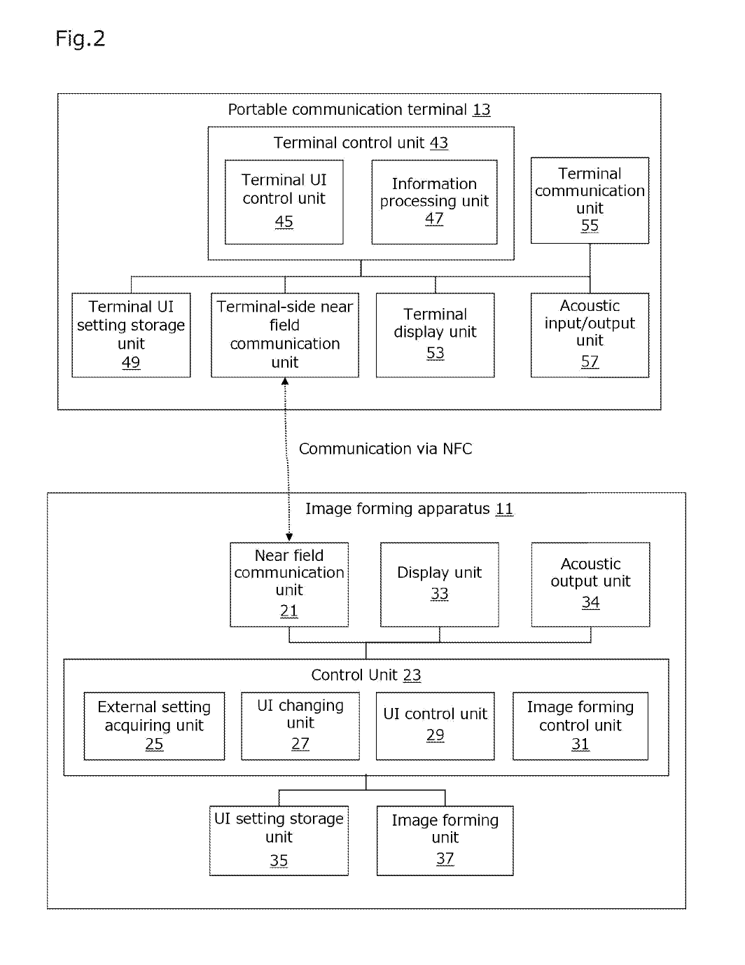

FIG. 2 is a block diagram illustrating the configurations of the image forming apparatus 11 and the portable communication terminal 13 illustrated in FIG. 1. In FIG. 2, the image forming apparatus includes a near field communication unit 21, a display unit 33, an acoustic output unit 34, a control unit 23, a UI setting storage unit 35, and an image forming unit 37.

In FIG. 2, the near field communication unit 21 makes communication with the portable communication terminal 13 with the NFC. In the case where the portable communication terminal 13 enters the communicable range, the near field communication unit 21 receives a response from the portable communication terminal 13 to recognize that the portable communication terminal 13 enters the communicable range. In this embodiment, the image forming apparatus 11 is placed in a public space to be used by unspecified number of users. FIGS. 1 and 2 illustrate only one portable communication terminal 13. However, the image forming apparatus 11 actually communicates with plural portable communication terminals carried by plural users.

The control unit 23 is mainly composed of a computer as a specific hardware configuration, and also includes a memory, an input/output circuit, and other peripheral circuits. The computer in the control unit 23 executes a control program, stored beforehand in the memory, to control the image forming apparatus 11. As representative functions of the control unit 23, an external setting acquiring unit 25, a UI changing unit 27, a UI control unit 29, and an image forming control unit 31 are described. However, the control unit 23 executes various processes not belonging to these functions.

Among these representative functions, the external setting acquiring unit 25 acquires a setting relating to a user interface of the portable communication terminal 13 via the near field communication unit.

The UI changing unit 27 changes a setting, stored in the UI setting storage unit 35, based on the setting acquired by the external setting acquiring unit 25.

The UI control unit 29 controls the user interface. Specifically, the UI control unit 29 controls the display unit 33 to display an operation screen. In the present embodiment, the display unit 33 includes a touch panel. The UI control unit 29 receives a user′ operation, detected by the touch panel, to the operation screen to update the operation screen and to issue an instruction relating to an image formation to the image forming control unit 31.

The image forming control unit 31 controls the operation of the image forming unit 37. The image forming control unit 31 also stores the setting relating to the user interface to the UI setting storage unit 35, or reads the stored setting and uses the read setting for the control of the user interface.

The display unit 33 displays the status and setting of the image forming apparatus 11 to a user. In the present embodiment, the display unit 33 includes a touch panel, and receives a user's operation. A liquid crystal display device with a touch panel is applied as hardware, for example.

The acoustic output unit 34 makes an announcement with a sound or generates an operation sound in response to an operation with the touch panel, and outputs these sounds from a speaker, as a part of the user interface.

The UI setting storage unit 35 is a non-volatile memory for storing a setting relating to the user interface, wherein a reading/writing action is controlled by the control unit 23. As hardware, a flash memory, an EEPROM, a RAM backed up by a battery, and a HDD can be used.

The image forming unit 37 performs an image formation relating to a job such as a copy, fax, photo service, printing service, and scan service. The image forming unit 37 is roughly composed of a hardware resource involved with reading of a document, a hardware resource involved with printing of a sheet, and a hardware resource involved with processing, reading, and writing of image data.

This is the configuration of the image forming apparatus 11. Next, the configuration of the portable communication terminal 13 will be described. The portable communication terminal 13 includes a terminal control unit 43, a terminal UI setting storage unit 49, a terminal-side near field communication unit 51, a terminal display unit 53, a terminal communication unit 55, and an acoustic input/output unit 57.

The terminal control unit 43 is mainly composed of a computer as a specific hardware configuration, and also includes a memory, an input/output circuit, and other peripheral circuits. The computer in the terminal control unit 43 executes a control program, stored beforehand in the memory, to control the portable communication terminal 13. As representative functions of the terminal control unit 43, the terminal UI control unit 45 and an information processing unit 47 are illustrated. However, the terminal control unit 43 executes various processes not belonging to these functions.

The terminal UI control unit 45 controls a user interface of the portable communication terminal 13. Specifically, the terminal UI control unit 45 controls the terminal display unit 53 of the portable communication terminal 13 to display various screens. The terminal display unit 53 includes a touch panel not illustrated. The terminal UI control unit 45 receives a user′ operation detected by the touch panel to update the operation screen, as well as to inform the information processing unit 47 of this operation and to allow the information processing unit 47 to execute necessary information process. The terminal UI control unit 45 also stores a setting relating to the user interface into the terminal UI setting storage unit 49, or reads the stored setting and uses the read setting for the control of the user interface.

The information processing unit 47 executes an application installed into the portable communication terminal 13, or performs a communication process via the terminal-side near field communication unit 51 or the terminal communication unit 55. The information processing unit 47 also performs a phone call process using the acoustic input/output unit 57.

The UI setting storage unit 35 is a non-volatile memory for storing a setting relating to the user interface, wherein a reading/writing action is controlled by the control unit 23. As hardware, a flash memory, an EEPROM, a RAM backed up by a battery, and a HDD can be used.

The terminal UI setting storage unit 49 is a non-volatile memory for storing a setting relating to the user interface, wherein a reading/writing action is controlled by the terminal control unit 43. As hardware, a flash memory, an EEPROM, and a RAM backed up by a battery can be used.

The terminal-side near field communication unit 51 communicates with the near field communication unit 21 of the image forming apparatus 11 via the NFC.

The terminal display unit 53 displays various information processes executed by the information processing unit 47, e.g., an execution of an application or a communication status and operation buttons used for these operations, to a user. In the present embodiment, the terminal display unit 53 includes a touch panel, and receives a user's operation. A liquid crystal display device with a touch panel is applied as hardware, for example.

The terminal communication unit 55 is an interface circuit that performs a wireless LAN communication such as Wi-Fi or a communication with CDMA or LTE.

The acoustic input/output unit 57 is a microphone and a speaker when the portable communication terminal 13 is used as a cellular phone.

As understood from FIG. 1, the configuration and function involved with the user interface is similar between the image forming apparatus 11 and the portable communication terminal 13. Therefore, it can be reasonable that the setting relating to the user interface of the image forming apparatus 11 is made or adjusted by referring to the setting relating to the user interface of the portable communication terminal 13.

### First Embodiment

Some specific examples of the setting relating to the user interface will be described below.

The first example is to select a language. The operation screen displayed on the display unit 33 by the UI control unit 29 includes description characters or message. These characters are displayed with various languages according to the setting of the language.

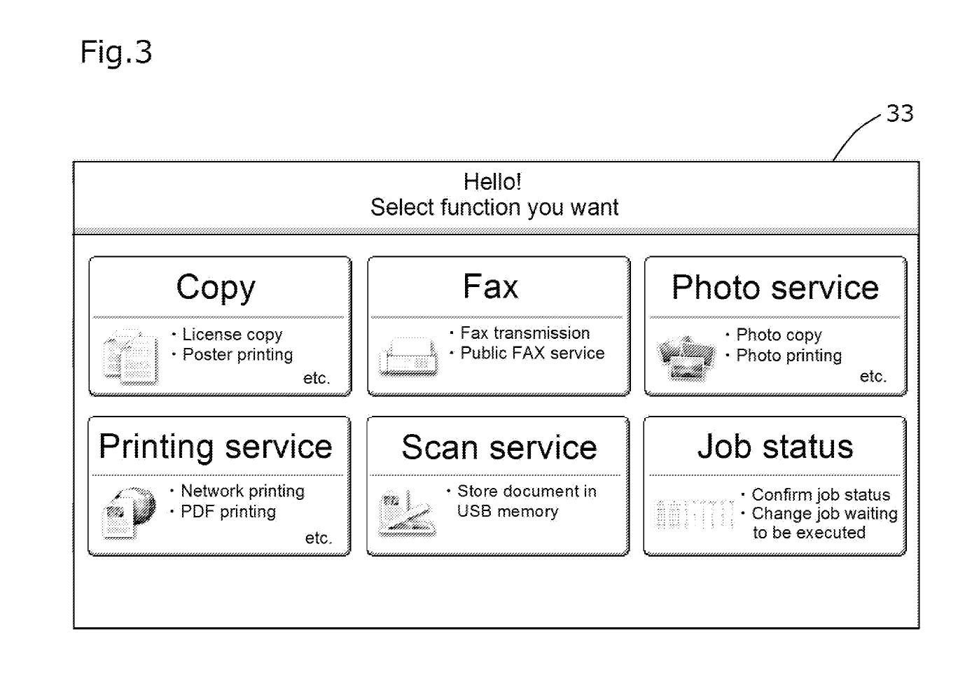

FIG. 3 is an explanatory view illustrating one example of the operation screen displayed on the display unit 33 in the present embodiment. In the operation screen in FIG. 3, six operation buttons are arranged. A name of each operation button and a description of its function are written on each button. For example, an operation button on which a name of a “copy” is written has terms of “license copy”, “poster printing”, and “etc.” as a description of the function. A region for displaying a message is formed above (at the far side from) the operation buttons. In FIG. 3, messages of “Hello!” and “select function you want” are displayed.

FIG. 3 illustrates an example that the set language is “Japanese”. However, supposing that the image forming apparatus 11 is set in foreign countries, operation screens for plural languages in corresponding countries are prepared. For example, English, German, French, Chinese, and Korean are considered. Various other languages according to the shipment destination of the image forming apparatus 11 are also prepared.

On the other hand, a language in a country where the portable communication terminal 13 is used can generally be selected for the portable communication terminal 13. For example, a language can be selected and changed by a language setting in Android (registered trademark) offered by Google Inc. and iOS (registered trademark) offered by Apple Inc., which are known as an operating system for a smartphone.

In recent days when international exchange is very popular, a user of the image forming apparatus 11 set in Japan is not limited to Japanese, for example. In the case where the image forming apparatus 11 is placed in a public space, it is considered that the case where only Japanese uses this image forming apparatus 11 is rare.

On the other hand, the portable communication terminal is a device personally used. Therefore, a language most familiar to a user of this portable communication terminal is considered to be set.

In view of this, in the present embodiment, when the near field communication unit 21 recognizes the portable communication terminal 13, the control unit 23 serving as the external setting acquiring unit 25 requests to the portable communication terminal 13 to provide data for a language setting via the near field communication unit 21. When the terminal control unit 43 in the portable communication terminal 13 transmits the detail of the language setting stored in the terminal UI setting storage unit 49 in response to this request, the external setting acquiring unit 25 acquires this language setting. If an operation screen for the language corresponding to the language setting is prepared, the control unit 23 changes the setting to display the operation screen with this language as the UI changing unit 27.

Specifically, the UI changing unit 27 reads the language setting stored in the UI setting storage unit 35, and checks whether or not the read language setting matches the language setting acquired from the portable communication terminal 13. When they match, the UI changing unit 27 ends the process. When they do not match, the UI changing unit 27 checks whether an operation screen with the corresponding language is present or not. If the operation screen with the corresponding language is not present, the UI changing unit 27 ends the process. On the other hand, if the operation screen with the corresponding language is present, the UI changing unit 27 changes the language setting stored in the UI setting storage unit 35, and notifies the UI control unit 29 of the changed language.

The UI control unit 29 updates the operation screen according to the notification from the UI changing unit 27.

In this way, the language of the operation screen displayed on the display unit 33 is changed based on the language setting of the portable communication terminal 13 carried by the user.

### Second Embodiment

As a modification, a setting screen by which the user selects a language may be displayed on the display unit 33 in the case where the language settings are different from each other, but the corresponding language is not present. This configuration is for allowing the user to select a language most familiar to the user out of the prepared languages.

### Third Embodiment

Another example is a size of a character. The operation screen in FIG. 3 includes characters of the description and message. The operation screen has a limitation in a size and arrangement of each buttons, so that the operation screen does not have a freedom of selecting a size of a character, compared to the screen of the portable communication terminal 13. However, characters of a few sizes can be prepared.

The image forming apparatus placed in a public space is used by various users of various ages, from boys to seniors. Therefore, it is preferable that the operation screen displays characters with a size according to user's eyesight.

On the other hand, there are many portable communication terminals 13 in which a size of a character displayed on a screen can be selected and changed in a few levels. Since a portable communication terminal is a device personally used, a size of a character is considered to be set to a size most easily read by each user.

In the present embodiment, when the near field communication unit 21 recognizes the portable communication terminal 13, the control unit 23 serving as the external setting acquiring unit 25 requests to provide data for a character size setting to the portable communication terminal 13 via the near field communication unit 21. When the terminal control unit 43 in the portable communication terminal 13 transmits the character size setting stored in the terminal UI setting storage unit 49 in response to this request, the external setting acquiring unit 25 acquires this setting data.

The control unit 23 compares the acquired character size to a normal setting. The control unit 23 decides the size of the character displayed on the display unit 33 according to whether the character size set by the user is larger or smaller than the normal setting and the degree of the difference between the character size set by the user and the normal setting. The control unit 23 then changes the character size setting stored in the UI setting storage unit 35.

It is considered that the size of the display screen of the portable communication terminal 13 and the size of the display screen of the display unit 33 are different from each other. However, a designer may prepare a range, which can be set, around a character size that is expected to be selected by a normal user.

The control unit 23 serving as the UI changing unit 27 checks to what extent the difference is generated between the normal setting or the setting supposed to be normal and the character size selected by each user. The UI changing unit 27 decides the size of the character displayed on the display unit 33 to have a correlation with the difference extent.

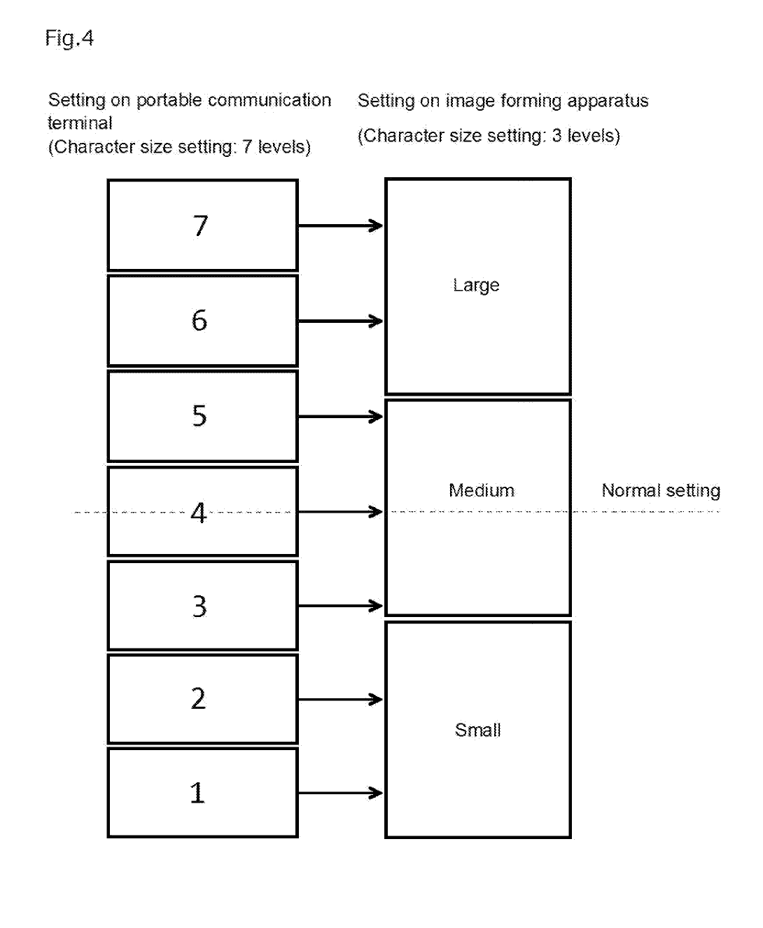

FIG. 4 is an explanatory view illustrating one example of a correspondence relation between the character size setting on the portable communication terminal 13 and the character size setting on the image forming apparatus 11 in the present embodiment. A left bar in FIG. 4 illustrates the character size setting on the portable communication terminal 13. Any one of character sizes in seven levels from the minimum “1” to the maximum “7” can be selected on the portable communication terminal 13. On the other hand, a right bar in FIG. 4 illustrates the character size setting on the image forming apparatus 11. Any one of character sizes in three levels, which are large, medium, and small, can be selected on the image forming apparatus 11. A chain line in the horizontal direction indicates a central value supposed to be the normal setting.

In the example in FIG. 4, before deciding the correspondence relation between both settings, the UI changing unit 27 relates central values of both settings to each other. Specifically, the UI changing unit 27 relates “4” in the character size setting on the portable communication terminal 13 to “medium” in the character setting on the image forming apparatus 11. The UI changing unit 27 also relates “3” and “5” adjacent to “4” to “medium”. The UI changing unit 27 also relates “1” and “2” in the character size setting on the portable communication terminal 13 to “small” in the character size setting on the image forming apparatus. The UI changing unit 27 also relates “6” and “7” in the character size setting on the portable communication terminal 13 to “large” in the character size setting on the image forming apparatus.

As described above, even if the levels in both settings are different, the UI changing unit 27 relates the normal settings or the set values supposed to be normal to each other, thereby deciding the correspondence relation according to the extent of the difference from the normal setting.

It is arranged beforehand such that, when the image forming apparatus 11 issues a request of setting, the portable communication terminal 13 returns a value or a range that can be set in this setting together with the set content. When the external setting acquiring unit 25 requests to transmit the setting relating to the user interface to the portable communication terminal 13, the portable communication terminal 13 receives this request via the terminal-side near field communication unit 51. The terminal control unit 43 returns the setting stored in the terminal UI setting storage unit 49 in response to this request. A character size is included in the returned setting. More specifically, the portable communication terminal 13 returns the condition in which the character size setting can assume any one of 1 to 7, and the selected set value.

When the setting is returned from the portable communication terminal 13, the external setting acquiring unit 25 decides the correspondence relation between the portable communication terminal 13 and the image forming apparatus 11. The UI changing unit 27 decides the setting of the image forming apparatus 11 based on the correspondence relation. For example, when “6” is returned as the selected set value, the UI changing unit 27 decides that the character size setting on the image forming apparatus 11 is set as “large” based on the correspondence relation. When the setting is different from the current setting, the UI changing unit 27 writes “large” into the UI setting storage unit 35. Then, the UI changing unit 27 notifies the UI control unit 29 of this change. The UI control unit 29 changes the size of the character displayed on the display unit 33 based on this notification.

### Fourth Embodiment

In the first to third embodiments, a setting example of the user interface relating to a display has been described. However, the interface may be a sound or tone user interface.

In the fourth embodiment, a sound or a tone set value is described as an example. As described with reference to FIG. 2, the image forming apparatus 11 includes the acoustic output unit 34. The portable communication terminal 13 includes the acoustic input/output unit 57 corresponding to the acoustic output unit 34.

When an output level of the acoustic output unit 34 can be adjusted, the control unit 23 requests to provide a setting of an acoustic output level to the portable communication terminal 13 as the external setting acquiring unit 25. When the terminal control unit 43 in the portable communication terminal 13 transmits the setting of the acoustic output level stored in the terminal UI setting storage unit 49 in response to this request, the external setting acquiring unit 25 acquires this setting data.

The control unit 23 compares the set value of the acquired acoustic output level and the normal setting. The control unit 23 decides a level of a sound or tone outputted from the acoustic output unit 34 according to whether the acoustic output level set by the user is larger or smaller than the normal setting and the degree of the difference between the acoustic output level set by the user and the normal setting. The control unit 23 then changes the setting of the output level stored in the UI setting storage unit 35.

The determination of the correspondence relation between the portable communication terminal 13 and the image forming apparatus 11 is similar to the case described in the third embodiment.

### Fifth Embodiment

When the acoustic output unit outputs a sound message, the control unit 23 may acquire a language setting from the portable communication terminal 13, and select a language of the sound message based on the acquired language setting.

### <<Flowchart>>

The detail described so far will be described as a process flow with reference to a flowchart.

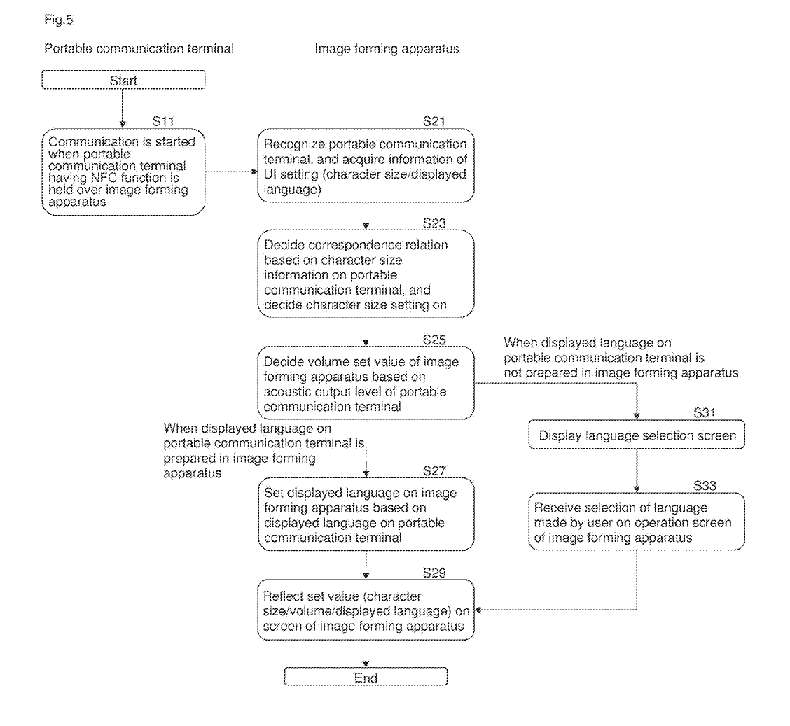

FIG. 5 is a flowchart illustrating the process flow executed by the terminal control unit 43 and the control unit 23 in FIG. 2.

In FIG. 5, when the portable communication terminal 13 having an NFC function is held over a predetermined position (e.g., a predetermined region around the display unit 33) of the image forming apparatus 11, the portable communication terminal 13 and the image forming apparatus 11 respectively recognize the presence of the counterpart device through a predetermined process (step S11). In the flowchart, the portable communication terminal is the device mainly executing the process. However, in step S11, the control unit 23 in the image forming apparatus 11 and the terminal control unit 43 in the portable communication terminal 13 respectively execute the process.

The control unit 23 that recognizes the presence of the portable communication terminal 13 requests to transmit the setting relating to the user interface of the portable communication terminal 13, and the terminal control unit 43 transmits the setting in response to this request. The control unit 23 serving as the external setting acquiring unit 25 acquires the setting transmitted from the portable communication terminal 13 (step S21). In the flowchart, the image forming apparatus mainly executes the process. However, in step S21, the control unit 23 in the image forming apparatus 11 and the terminal control unit 43 in the portable communication terminal 13 respectively execute the process.

The control unit 23 firstly decides the correspondence relation of character size settings between the portable communication terminal 13 and the image forming apparatus 11, out of the acquired settings. Then, the control unit 23 decides the character size setting based on the setting on the portable communication terminal 13 (step S23).

Then, the control unit 23 decides the correspondence relation for the setting of the acoustic output level, out of the settings acquired in step S21, between the portable communication terminal 13 and the image forming apparatus 11, and decides the setting of an output volume based on the setting on the portable communication terminal 13 (step S25).

Next, the control unit 23 checks whether the language settings, out of the settings acquired in step S21, match or not between the portable communication terminal 13 and the image forming apparatus 11. When they do not match, and the corresponding language is prepared, the control unit 23 decides that the language on the image forming apparatus 11 is set to be the same as the language on the portable communication terminal 13 (step S27).

Then, the control unit 23 writes the settings decided in steps S23 to S27 on the UI setting storage unit 35, notifies the UI control unit 29, and changes the display on the display unit 33 according to the settings (step S29). The control unit 23 then ends the process.

On the other hand, when the language settings are different and the corresponding language is not prepared, the control unit 23 displays a menu screen for selecting a language on the display unit 33 to encourage the user to select a language, instead of the execution of the process in step S27 (step S31). The control unit 23 receives the language selected by the user on the menu screen (step S33). Thereafter, the routine proceeds to step S29 where the setting is reflected.

As described above, an image forming apparatus according to the present invention includes: a display unit that displays information relating to a user interface; a UI setting storage unit that stores a setting relating to the user interface; a near field communication unit that communicates with a portable communication terminal via a near field communication to recognize that the portable communication terminal is within a communicable range; an external setting acquiring unit that receives a setting relating to a user interface of the portable communication terminal via the near field communication unit; and a UI setting changing unit that changes the setting stored in the UI setting storage unit based on the setting acquired from the portable communication terminal.

Preferable aspects of the present invention will further be described

The UI setting storage unit may stores a type of a language that is to be displayed on the display unit, the external setting acquiring unit may acquire a language setting on the portable communication terminal, and the UI setting changing unit may change the type of the language stored in the UI setting storage unit so as to conform a language displayed on the display unit to the language setting acquired by the external setting acquiring unit.

According to this configuration, the display on the display unit of the image forming apparatus can be changed to the language setting suitable for a user based on the setting of the portable communication terminal carried by the user.

The UI setting storage unit may store a level of a size of a character that is to be displayed on the display unit, the external setting acquiring unit may acquire a setting of a size of a displayed character on the portable communication terminal, and the UI setting changing unit may change the level of the character size stored in the UI setting storage unit based on the setting of the size of the displayed character acquired by the external setting acquiring unit.

According to this configuration, the display on the display unit of the image forming apparatus can be changed to the size suitable for a user based on the setting of the portable communication terminal carried by the user.

The image forming apparatus may further include an acoustic output unit that outputs a sound or a tone relating to the user interface, wherein the UI setting storage unit may store a level of a magnitude of a sound outputted from the acoustic output unit, the external setting acquiring unit may acquire a setting of a magnitude of an output sound on the portable communication terminal, and the UI setting changing unit may change the level of the magnitude of the sound stored in the UI setting storage unit based on the setting of the magnitude of the output sound acquired by the external setting acquiring unit.

According to this configuration, the output level from the acoustic output unit of the image forming apparatus can be changed to the sound level suitable for a user based on the setting of the portable communication terminal carried by the user.

The acoustic output unit may output a sound, the UI setting storage unit may store a language of the sound outputted from the acoustic output unit, the external setting acquiring unit may acquire a language setting on the portable communication terminal, and the UI setting changing unit may change the language setting of a sound stored in the UI setting storage unit according to the language setting acquired by the external setting acquiring unit.

According to this configuration, the sound of the language can be changed to the one suitable for a user based on the setting of the portable communication terminal carried by the user.

The UI setting changing unit may compare the size setting, acquired by the external setting acquiring unit, on the portable communication terminal and a predetermined normal setting, and may change the setting stored in the UI setting storage unit according to whether the size setting is larger or smaller than the normal setting and according to an extent of a difference between the size setting and the normal setting.

According to this configuration, even if the setting on the portable communication terminal does not correspond one-to-one with the setting on the image forming apparatus, a setting having correlation can be set.

The preferable aspects of the present invention include the one formed by combining some of the above-mentioned plural aspects.

Besides the above-mentioned embodiments, various modifications for the present invention are possible. These modifications should not be construed as not belonging to the scope of the present invention. The accompanying claims and their equivalents are intended to cover such forms or modifications as would fall within the scope of the invention.

What is claimed is:

1. An image forming apparatus comprising:
a display unit that displays information relating to a user interface;
a UI setting storage unit that stores a setting relating to the user interface;
a near field communication unit that communicates with a portable communication terminal via a near field communication to recognize that the portable communication terminal is within a communicable range;
an external setting acquiring unit that receives a setting relating to a user interface of the portable communication terminal via the near field communication unit; and
a UI setting changing unit that changes the setting stored in the UI setting storage unit based on the setting acquired from the portable communication terminal.

2. The image forming apparatus according to claim 1, wherein
the UI setting storage unit stores a type of a language that is to be displayed on the display unit,
the external setting acquiring unit acquires a language setting on the portable communication terminal, and
the UI setting changing unit changes the type of the language stored in the UI setting storage unit so as to conform a language displayed on the display unit to the language setting acquired by the external setting acquiring unit.

3. The image forming apparatus according to claim 1, wherein
the UI setting storage unit stores a level of a size of a character that is to be displayed on the display unit,
the external setting acquiring unit acquires a setting of a size of a displayed character on the portable communication terminal, and
the UI setting changing unit changes the level of the character size stored in the UI setting storage unit based on the setting of the size of the displayed character acquired by the external setting acquiring unit.

4. The image forming apparatus according to claim 1, further comprising:
an acoustic output unit that outputs a sound or a tone relating to the user interface, wherein
the UI setting storage unit stores a level of a magnitude of a sound outputted from the acoustic output unit,
the external setting acquiring unit acquires a setting of a magnitude of an output sound on the portable communication terminal, and
the UI setting changing unit changes the level of the magnitude of the sound stored in the UI setting storage unit based on the setting of the magnitude of the output sound acquired by the external setting acquiring unit.

5. The image forming apparatus according to claim 4, wherein
the acoustic output unit outputs a sound,
the UI setting storage unit stores a language of the sound outputted from the acoustic output unit,
the external setting acquiring unit acquires a language setting on the portable communication terminal, and
the UI setting changing unit changes the language setting of a sound stored in the UI setting storage unit according to the language setting acquired by the external setting acquiring unit.

6. The image forming apparatus according to claim 3, wherein
the UI setting changing unit compares the size setting, acquired by the external setting acquiring unit, on the portable communication terminal and a predetermined normal setting, and changes the setting stored in the UI setting storage unit according to whether the size setting is larger or smaller than the normal setting and according to an extent of a difference between the size setting and the normal setting.
